(19) United States
(12) Patent Application Publication
(10) Pub. No.: US 2025/0027444 A1
(43) Pub. Date: Jan. 23, 2025

(54) ROTATING DETONATION COMBUSTOR SYSTEM AND METHOD OF OPERATING THE ROTATING DETONATION COMBUSTOR SYSTEM

(71) Applicant: BorgWarner Inc., Auburn Hills, MI (US)

(72) Inventors: Jan Kindracki, Grodzisk Mazowiecki (PL); Lukasz Jan Kapusta, Warszawa (PL); Piotr Jaworski, Glogow Malopolski (PL); Michal Zatek, Zbyslavice (CZ); John Robert Zagone, Hendersonville, NC (US)

(21) Appl. No.: 18/777,047

(22) Filed: Jul. 18, 2024

Related U.S. Application Data
(60) Provisional application No. 63/527,660, filed on Jul. 19, 2023.

(51) Int. Cl. F02C 5/02; F02C 3/14; F23R 7/00

(52) U.S. Cl. CPC F02C 5/02; F02C 3/14; F23R 7/00

(57) ABSTRACT

A rotating detonation combustor system includes a rotating detonation combustor having an outer wall, and inner wall, and a combustion chamber configured to receive a fuel and an oxidizing agent and expel exhaust gas. The rotating detonation combustor system also includes a turbine wheel in fluid communication with the combustion chamber and configured to rotate upon receiving the exhaust gas, a shaft rotatable with the turbine wheel, and a compressor wheel rotatable with the shaft, in fluid communication with the combustion chamber, and configured to deliver compressed oxidizing agent to the combustion chamber. The rotating detonation combustor system further includes an electric machine rotatable with the shaft. The electric machine is configured to convert at least one of rotational motion of the shaft to electrical energy, and electrical energy to rotational motion of the shaft.

### CROSS-REFERENCE TO RELATED APPLICATIONS

This application claims priority to and all the benefits of U.S. Provisional Application No. 63/527,660, filed Jul. 19, 2023, which is hereby incorporated by reference in its entirety.

### BACKGROUND OF THE INVENTION

### 1. Field of the Invention

The invention generally relates to a rotating detonation combustor system, and a method of operating the rotating detonation combustor system.

### 2. Description of the Related Art

Systems commonly convert chemical energy in fuel to electrical energy. The systems typically include an internal combustion engine defining a combustion chamber for receiving a mixture of fuel and air. The mixture of fuel and air is combusted in the combustion chamber at sub-sonic speeds in a process commonly known as deflagration. The combustion of the fuel and air generates hot exhaust gas which is then expelled from the combustion chamber and directed toward a turbine generator. The turbine generator typically includes a turbine wheel coupled to an electric generator through a shaft. The exhaust gas from the combustion chamber rotates the turbine wheel and the shaft, and the electric generator converts the rotational motion of the turbine wheel and shaft to electrical energy.

However, internal combustion engines are often inefficient in converting chemical energy in fuel to electrical energy. More specifically, internal combustion engines are thermodynamically limited to the efficiencies of the Brayton Cycle (e.g., combustion at near constant pressure) and thus have mechanical, thermal, and thermodynamic energy losses which directly affect the efficiency of converting chemical energy in fuel to electrical energy.

As such, there remains a need for an improved system for converting chemical energy in fuel to electrical energy.

### SUMMARY OF THE INVENTION AND ADVANTAGES

A rotating detonation combustor system includes a rotating detonation combustor extending along an axis. The rotating detonation combustor has an outer wall extending along and circumferentially about the axis and has an inner wall extending along and circumferentially about the axis. The inner wall is spaced radially inward relative to the outer wall such that a combustion chamber is defined between the outer wall and the inner wall. The rotating detonation combustor is configured to receive a fuel and an oxidizing agent into the combustion chamber and expel exhaust gas from the combustion chamber.

The rotating detonation combustor system also includes a turbine wheel in fluid communication with the combustion chamber. The turbine wheel is configured to rotate upon receiving the exhaust gas. The rotating detonation combustor system further includes a shaft rotatable with the turbine wheel and a compressor wheel rotatable with the shaft. The compressor wheel is in fluid communication with the combustion chamber and is configured to deliver compressed oxidizing agent to the combustion chamber. The rotating detonation combustor system further includes an electric machine rotatable with the shaft. The electric machine is configured to convert at least one of rotational motion of the shaft to electrical energy, and electrical energy to rotational motion of the shaft.

Accordingly, the rotating detonation combustor system is able to convert chemical energy in fuel to electrical energy through combustion of the fuel in the rotating detonation combustor, through expel the exhaust gas to rotate the turbine wheel and the shaft, and through convert the rotational motion of the shaft to electrical energy by the electric machine. Moreover, the electric machine is also able to use electrical energy to rotate the shaft, and thus also rotate the compressor wheel, ensuring that an adequate flow rate and pressure of the oxidizing agent is delivered by the compressor wheel to the combustion chamber. Ensuring adequate flow rate and pressure of the oxidizing agent to the combustion chamber through use of the electric machine is advantageous during periods of operation of the rotating detonation combustor when the flow of exhaust gas to the turbine wheel cannot alone rotate the compressor wheel with sufficient force to supply the combustion chamber with an adequate flow rate and pressure of the oxidizing agent, such as during start-up of the rotating detonation combustor.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic illustration of the rotating detonation combustor system including the rotating detonation combustor extending along a first axis and a compressor wheel, a shaft, an electric machine, and a turbine wheel extending along a second axis;

FIG. 2A is a schematic illustration of the rotating detonation combustor system, with the rotating detonation combustor, the compressor wheel, the shaft, the electric machine, and the turbine wheel extending along the first axis, and with the electric machine disposed between the compressor wheel and the turbine wheel;

FIG. 2B is a schematic illustration of the rotating detonation combustor system, with the rotating detonation combustor, the compressor wheel, the shaft, the electric machine, and the turbine wheel extending along the first axis, and with the compressor wheel disposed between the electric machine and the turbine wheel;

FIG. 2C is a schematic illustration of the rotating detonation combustor system, with the rotating detonation combustor, the compressor wheel, the shaft, the electric machine, and the turbine wheel extending along the first axis, and with the turbine wheel disposed between the compressor wheel and the electric machine;

FIG. 3 is a cut-away perspective view of the rotating detonation combustor;

FIG. 4 is a flow diagram of a method of operating the rotating detonation combustor system; and

FIG. 5 is a flow diagram of another method of operating the rotating detonation combustor system.

### DETAILED DESCRIPTION OF THE INVENTION

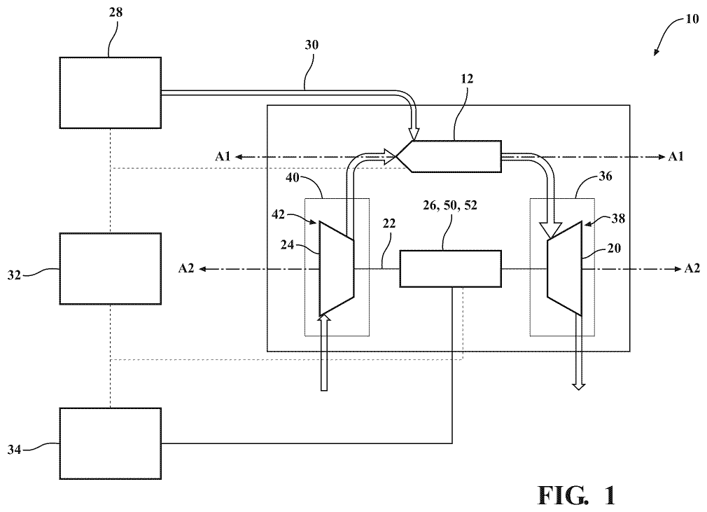

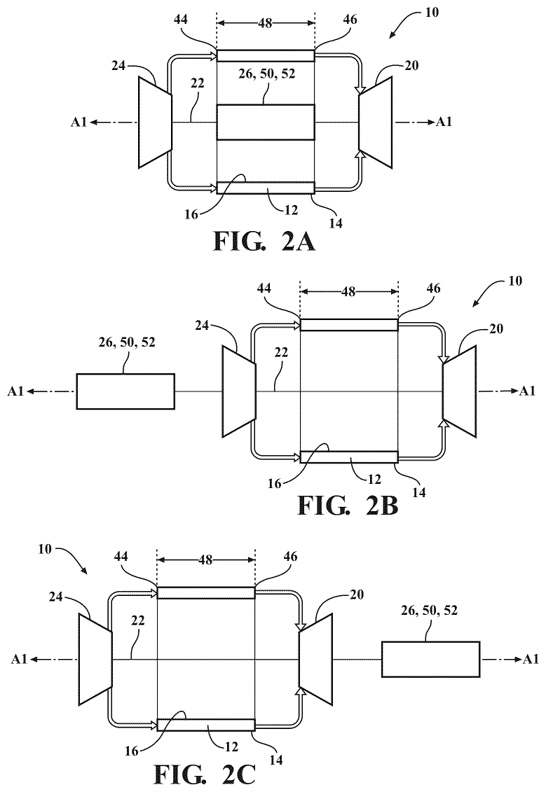

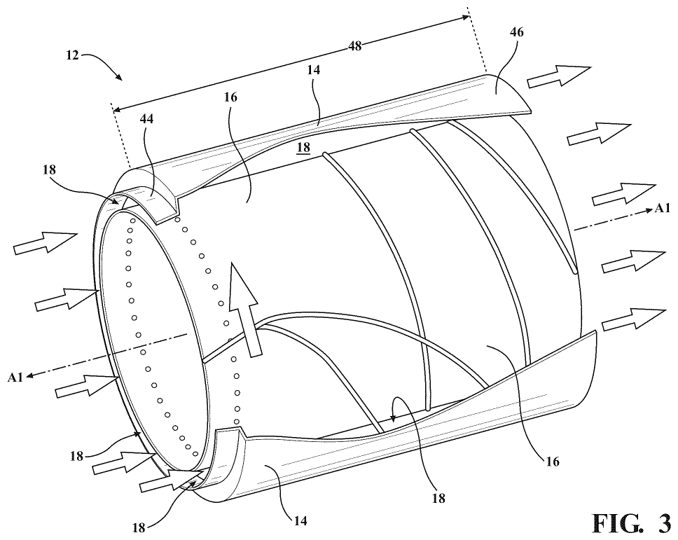

With reference to the Figures, wherein like numerals indicate like parts throughout the several views, a rotating detonation combustor system 10 is shown in FIGS. 1 and 2A-2C. The rotating detonation combustor system 10 includes a rotating detonation combustor 12 extending along an axis A1. The rotating detonation combustor 12 has an outer wall 14 extending along and circumferentially about the axis A1 and has an inner wall 16 extending along and circumferentially about the axis A1. The inner wall 16 is spaced radially inward relative to the outer wall 14 such that a combustion chamber 18 is defined between the outer wall 14 and the inner wall 16. The rotating detonation combustor 12 is configured to receive a fuel and an oxidizing agent into the combustion chamber 18 and expel exhaust gas from the combustion chamber 18. It is to be appreciated that the outer wall 14 and the inner wall 16 typically do not move, such as by rotation relative to one another. Moreover, the rotating detonation combustor 12 may have little to no moving components.

The rotating detonation combustor system 10 also includes a turbine wheel 20 in fluid communication with the combustion chamber 18. The turbine wheel 20 is configured to rotate upon receiving the exhaust gas. The rotating detonation combustor system 10 further includes a shaft 22 rotatable with the turbine wheel 20 and a compressor wheel 24 rotatable with the shaft 22. The compressor wheel 24 is in fluid communication with the combustion chamber 18 and is configured to deliver compressed oxidizing agent to the combustion chamber 18. The rotating detonation combustor system 10 further includes an electric machine 26 rotatable with the shaft 22. The electric machine 26 is configured to convert at least one of rotational motion of the shaft 22 to electrical energy, and electrical energy to rotational motion of the shaft 22.

Accordingly, the rotating detonation combustor system 10 is able to convert chemical energy in fuel to electrical energy through combustion of the fuel in the rotating detonation combustor 12, through expulsion of the exhaust gas to rotate the turbine wheel 20 and the shaft 22, and through conversion of the rotational motion of the shaft 22 to electrical energy by the electric machine 26. Moreover, the electric machine 26 is also to use electrical energy to rotate the shaft 22, and thus also rotate the compressor wheel 24, ensuring that an adequate flow rate and pressure of the oxidizing agent is delivered by the compressor wheel 24 to the combustion chamber 18. Ensuring adequate flow rate and pressure of the oxidizing agent to the combustion chamber 18 through use of the electric machine 26 is advantageous during periods of operation of the rotating detonation combustor 12 when the flow of exhaust gas to the turbine wheel 20 cannot alone rotate the compressor wheel 24 with sufficient force to supply the combustion chamber 18 with an adequate flow rate and pressure of the oxidizing agent, such as during start-up of the rotating detonation combustor 12.

Although not required, the rotating detonation combustor system 10 may also include a pump 28 and a fuel line 30 in fluid communication with the combustion chamber 18. The pump 28 is configured to direct the fuel through the fuel line 30 to the combustion chamber 18. The rotating detonation combustor system 10 may also include a control unit 32 configured to operate the pump 28 to either direct fuel through the fuel line 30 to the combustion chamber 18, or to refrain from directing fuel through the fuel line 30 to the combustion chamber 18. The control unit 32 may also be configured to control operation of the electric machine 26, and the control unit 32 may further be configured to control operation of the rotating detonation combustor 12, for example, by controlling an ignition process which determines when the rotating detonation combustor ignites. The ignition process may be designed to promote transition from deflagration to detonation. The rotating detonation combustor system 10 may further include a power grid 34 incorporating a battery and a direct current converter to supply power to the control unit 32. It is to be appreciated that the power grid 34 may be powered by the electric machine 26, and thus the rotating detonation combustor system 10 requires no external power source.

Moreover, in one embodiment as shown in FIG. 1, the shaft 22 may extend along a second axis A2 different from the axis A1 along which the rotating detonation combustor 12 extends. As such, it is to be appreciated that the axis A1 may be further defined as a first axis A1. The rotating detonation combustor system 10 may also further include a turbine volute housing 36 defining a turbine volute interior 38 and a compressor volute housing 40 defining a compressor volute interior 42. It is to be appreciated that the turbine volute housing 36 may be a single volute turbine housing, a dual volute turbine housing, or a twin scroll turbine housing, as non-limiting examples. Moreover, the turbine wheel 20 may be disposed in the turbine volute interior 38 and the compressor wheel 24 may be disposed in the compressor volute interior 42. Additionally, the rotating detonation combustor system 10 may include one or more additional housings, such as a bearing housing, fixed between the turbine volute housing 36 and the compressor volute housing 40.

It is to be appreciated that the compressor wheel 24, the compressor volute housing 40, the shaft 22, the turbine wheel 20, and the turbine volute housing 36 may together form a turbocharger. The electric machine 26 may be co-axial with the second axis A2, thus forming an electric turbocharger, which is also known as an e-turbocharger or an e-turbo. It is to be appreciated that the electric machine 26 may be both co-axial with the second axis A2 and disposed between the compressor wheel 24 and the turbine wheel 20 in the electric turbocharger. It is to be appreciated that the turbocharger, whether in the form of an electric turbocharger or otherwise, does not require a wastegate or a variable turbine geometry (VTG) assembly, although the turbocharger may include a wastegate or a variable turbine geometry (VTG) assembly.

In another embodiment, as shown in FIGS. 2A-2C, the turbine wheel 20 and the compressor wheel 24 may be coaxial with the axis A1 along which the rotating detonation combustor 12 extends. The electric machine 26 may also be coaxial with the axis A1 along which the rotating detonation combustor 12 extends. As a non-limiting example, the electric machine 26 may be spaced radially inward relative to the inner wall 16 of the rotating detonation combustor 12.

Moreover, the rotating detonation combustor 12 extends along the axis A1 between a first combustor end 44 and a second combustor end 46 spaced from the first combustor end 44 along the axis A1. As shown in FIG. 2A, the electric machine 26 may be at least partially disposed between the first combustor end 44 and the second combustor end 46. It is to be appreciated that the electric machine 26 may be completely disposed between the first combustor end 44 and the second combustor end 46. Disposing the electric machine 26 between the first combustor end 44 and the second combustor end 46 permits the rotating detonation combustor system 10 to be compact. Additionally, the electric machine 26 may be disposed between the turbine wheel 20 and the compressor wheel 24, further permitting the rotating detonation combustor system 10 to be compact and additionally stabilizes the dynamics of the rotating compressor wheel 24, shaft 22, and turbine wheel 20. It is to be appreciated that the compressor wheel 24 may be spaced from the first combustor end 44 such that the first combustor end 44 is disposed between the compressor wheel 24 and the electric machine 26, and the turbine wheel 20 may be spaced from the second combustor end 46 such that the second combustor end 46 is disposed between the turbine wheel 20 and the electric machine 26.

As shown in FIG. 2B and FIG. 2C, the electric machine 26 may be disposed outside of an axial boundary 48 between the first combustor end 44 and the second combustor end 46. Disposing the electric machine 26 outside of the axial boundary 48 between the first combustor end 44 and the second combustor end 46 reduces heat transfer from the rotating detonation combustor 12 to the electric machine 26 which may impact the performance of the electric machine 26. As shown in FIG. 2B, the compressor wheel 24 may be disposed between the electric machine 26 and the turbine wheel 20. As shown in FIG. 2C, the turbine wheel 20 is disposed between the electric machine 26 and the compressor wheel 24.

The compressor wheel 24, the electric machine 26, and the turbine wheel 20 being coaxial with the rotating detonation combustor 12 permits simplification of the housing(s) of the rotating detonation combustor system 10, such as the turbine volute housing 36, the compressor volute housing 40, and optionally the bearing housing when present. More specifically, the rotating detonation combustor system 10 does not require the compressor volute housing 40 or the turbine volute housing 36 in the embodiments where the compressor wheel 24, the electric machine 26, and the turbine wheel 20 are coaxial with the rotating detonation combustor 12. Instead, a single housing may either enclose the rotating detonation combustor 12, the compressor wheel 24, the turbine wheel 20, and optionally the electric machine 26. The single housing may be integral with the outer wall 14 of the rotating detonation combustor 12 or may be disposed about the outer wall 14 of the rotating detonation combustor 12. As such, a direct flow path from the compressor wheel 24 to the combustion chamber 18 and to the turbine wheel 20 may be established.

In one embodiment, the electric machine 26 is further defined as an electric generator 50 configured to only convert rotational motion of the shaft 22 to electrical energy. In another embodiment, the electric machine 26 is further defined as an electric motor 52 configured to only convert electrical energy to rotational motion of the shaft 22. However, the electric machine 26 may selectively function as both the electric generator 50 and the electric motor 52. The electric machine 26 may be configured to both convert rotational motion of the shaft 22 to electrical energy, and convert electrical energy to rotational motion of the shaft 22.

In a non-limiting example, the fuel that the rotating detonation combustor 12 is configured to receive includes hydrogen gas. Hydrogen gas advantageously produces no carbon dioxide emissions. However, it is to be appreciated that the rotating detonation combustor 12 is flexible in which type of fuel it may receive, including but not limited to hydrocarbon-based fuels, gasoline, kerosene, natural gas, and jet fuel, either alone, in mixtures with hydrogen gas, or in mixtures of any combination of hydrogen gas, hydrocarbon-based fuels, gasoline, kerosene, natural gas, and jet fuel. In a non-limiting example, the oxidizing agent that the rotating detonation combustor 12 is configured to receive is air. However, it is to be appreciated that the rotating detonation combustor is flexible in which type of oxidizing agent it may receive, including but not limited to pure oxygen and a mixture of air and pure oxygen such that the mixture has a greater relative concentration of oxygen as compared to air.

Although not required, the fuel and the oxidizing agent may be combusted under lean conditions. Combustion in the combustion chamber 18 generates significant heat, particularly because the rotating detonation combustor 12 is highly efficient. However, combusting the fuel and the oxidizing agent under lean conditions mitigates the rate at which heat is generated and thus assists in maintaining the temperature of the rotating detonation combustor system 10 and the exhaust gas within acceptable and safe limits. Moreover, combusting the fuel and the oxidizing agent under lean conditions improves the specific fuel consumption (SFC) and lowers or reduces nitrogen oxide (NOx) emissions.

Moreover, the fuel may be combusted in a detonation. More specifically, the fuel and the oxidizing agent may be combusted in a detonation wave which propagates at supersonic speed continuously around the combustion chamber 18. It is to be appreciated that the combustion chamber 18 may be defined to be annular, and thus the detonation wave may propagate along an annular path. Said differently, the combustion chamber 18 may be defined as a ring in cross-section, and the detonation wave may appear to “spin” radially about the ring of the combustion chamber 18. The detonation wave may be initiated by the ignition process. It is to be appreciated that the oxidizing agent, the fuel, and the exhaust gas also may travel along the annular path, but also travel along the axis A1 toward the second combustor end 46.

Detonation results in greater efficiency of combustion as compared to deflagration, and, as such, the rotating detonation combustor 12 has increased thermodynamic efficiencies. More specifically, the thermodynamic efficiencies of the rotating detonation combustor 12 may be described by the Fickett-Jacobs Cycle (i.e., detonation cycle) and thus are not limited to combustion at near constant pressure (e.g. the Brayton Cycle of internal combustion engines) and produce additional work as compared to combustion at near constant pressure. Thus, the thermodynamic efficiencies of the rotating detonation combustor 12 may be approximately 5-7% greater than the thermodynamic efficiencies of an internal combustion engine undergoing deflagration according to the Brayton Cycle.

The detonation wave, once initiated, may be self-sustaining for as long as the fuel and the oxidizing agent are continuously fed to the combustion chamber 18. As such, the electric machine 26 being configured to convert electrical energy to rotational motion of the shaft 22 assists in maintaining the self-sustaining detonation wave even when the electric machine 26 is primarily being used to convert rotational motion of the shaft 22 to electrical energy. More specifically, the electric machine 26 may convert electrical energy to rotational motion of the shaft 22, thus supplementing the flow rate and/or pressure of the oxidizing agent to the combustion chamber 18 and avoiding ending the self-sustaining detonation wave and requiring re-initiation of the detonation wave. The electric machine 26 being configured to convert electrical energy to rotational motion of the shaft 22 also assists in initiation of the detonation wave by supplying compressed oxidizing agent to the combustion chamber 18 before exhaust gas is available to rotate the turbine wheel 20 and thus rotate the compressor wheel 24.

The rotating detonation combustor system 10 may be used in a variety of applications. In non-limiting examples, the rotating detonation combustor system 10 may be used as a range-extender for electric vehicles or hybrid-electric vehicles and machinery, as a back-up power generator such as for a hospital or other building, or as a standalone power generator.

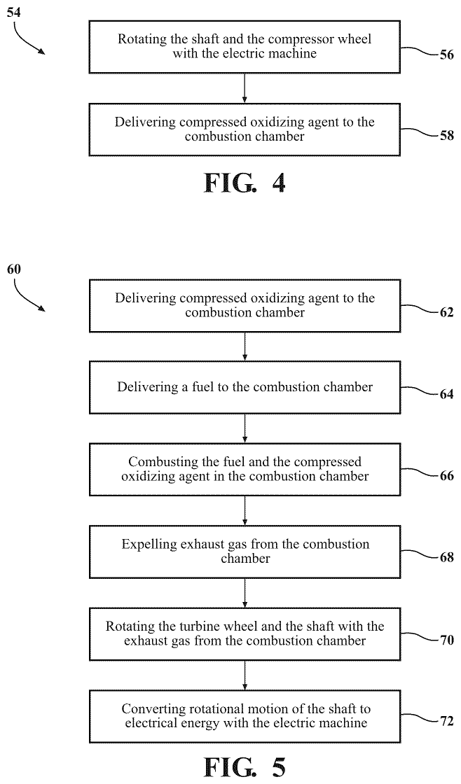

A method 54 of operating the rotating detonation combustor system 10 is also provided, as shown in a FIG. 4. The method 54 includes the step 56 of rotating the shaft 22 and the compressor wheel 24 with the electric machine 26, and includes the step 58 of delivering compressed oxidizing agent to the combustion chamber 18. In this method 54, the electric machine 26 may operate as the electric motor 52 and thus may be configured to only convert electrical energy to rotational motion of the shaft 22. However, in this method 54, the electric machine 26 may still be configured to convert rotational motion of the shaft 22 to electrical energy even if the electric machine 26 is not actively converting rotational motion of the shaft 22 to electrical energy.

The step 58 of delivering compressed oxidizing agent to the combustion chamber 18 may include flushing the combustion chamber 18 of fuel. In other words, during delivery of compressed oxidizing agent to the combustion chamber 18, the pump 28 may not be delivering fuel through the fuel line 30 to the combustion chamber 18. As such, there may be no detonation possible. Instead, the compressed oxidizing agent flushes the combustion chamber 18, thus removing residual fuel which may still remain in the combustion chamber 18, for example, on the outer wall 14 or the inner wall 16 of the rotating detonation combustor 12. Residual fuel remaining in the combustion chamber 18 presents a safety concern. Thus, flushing the combustion chamber 18 of fuel increases the safety of the rotating detonation combustor system 10, particularly when not in use.

The method 54 may further include the steps of delivering the fuel to the combustion chamber 18, combusting the fuel and the compressed oxidizing agent in the combustion chamber 18, expelling exhaust gas from the combustion chamber 18, and rotating the turbine wheel 20 and the shaft 22 with the expelled exhaust gas from the combustion chamber 18. Thus, instead of flushing the combustion chamber 18, the delivery of compressed oxidizing agent to the combustion chamber 18 may be used to initiate operation of the rotating detonation combustor 12. The step of delivering the fuel to the combustion chamber 18 may include operating the pump 28 to deliver the fuel through the fuel line 30 and may also optionally include controlling operation of the pump 28 with the control unit 32. It is to be appreciated that the step of combusting the fuel and the compressed oxidizing agent in the combustion chamber 18 may be accomplished with a lean mixture of the fuel and the compressed oxidizing agent.

Although not required, as described herein, in the method 54 described above the electric machine 26 may still be configured to convert rotational motion of the shaft 22 to electrical energy. As such, the method 54 may further include the step of converting rotational motion of the shaft 22 to electrical energy with the electric machine 26. The method 54 may include the step of determining a stable operating point of the rotating detonation combustor 12, and the step of switching the electric machine 26 from converting electrical energy to rotational motion of the shaft 22 to converting rotational motion of the shaft 22 to electrical energy upon determination of the stable operating point of the rotating detonation combustor 12. The stable operating point of the rotating detonation combustor 12 may be steady-state operation, although it need not be.

It is therefore to be understood that the electric machine 26 may serve at least three purposes in the method 54—to initiate operation of the rotating detonation combustor 12, to generate electricity once operation has been initiated, and to flush the combustion chamber 18 of residual fuel once operation has ceased. Consistent with the description herein, the step of rotating the shaft 22 with the electric machine 26 may thus precede the step of converting rotational motion of the shaft 22 to electrical energy with the electric machine 26.

Another method 60 of operating the rotating detonation combustor system 10 is shown in FIG. 5. The method 60 may include the step 62 of delivering compressed oxidizing agent to the combustion chamber 18, the step 64 of delivering the fuel to the combustion chamber 18, the step 66 of combusting the fuel and the compressed oxidizing agent in the combustion chamber 18, the step 68 of expelling exhaust gas from the combustion chamber 18, the step 70 of rotating the turbine wheel 20 and the shaft 22 with the exhaust gas from the combustion chamber 18, and the step 72 of converting rotational motion of the shaft 22 to electrical energy with the electric machine 26. In this method 60, the electric machine 26 may operate as the electric generator 50 and may only be configured to convert rotational motion of the shaft 22 to electrical energy. As such, in this method 60, the electric machine 26 need not be able to operate as the electric motor 52. As such, the step 62 of delivering compressed oxidizing agent to the combustion chamber 18 need not be associated with, or accompanied by, the step 56 of rotating the shaft 22 and the compressor wheel 24 with the electric machine 26.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A rotating detonation combustor system comprising:
a rotating detonation combustor extending along an axis, having an outer wall extending along and circumferentially about said axis, and having an inner wall extending along and circumferentially about said axis, with said inner wall spaced radially inward relative to said outer wall such that a combustion chamber is defined between said outer wall and said inner wall, and with said rotating detonation combustor configured to receive a fuel and an oxidizing agent into said combustion chamber and expel exhaust gas from said combustion chamber;
a turbine wheel in fluid communication with said combustion chamber and configured to rotate upon receiving the exhaust gas;
a shaft rotatable with said turbine wheel;
a compressor wheel rotatable with said shaft, said compressor wheel in fluid communication with said combustion chamber and configured to deliver compressed oxidizing agent to said combustion chamber; and
an electric machine rotatable with said shaft and configured to convert at least one of rotational motion of said shaft to electrical energy, and electrical energy to rotational motion of said shaft.

2. The rotating detonation combustor system of claim 1, wherein said shaft extends along a second axis different from said axis along which said rotating detonation combustor extends.

3. The rotating detonation combustor system of claim 1, wherein said turbine wheel and said compressor wheel are coaxial with said axis along which said rotating detonation combustor extends.

4. The rotating detonation combustor system of claim 1, wherein said electric machine is coaxial with said axis along which said rotating detonation combustor extends.

5. The rotating detonation combustor system of claim 4, wherein said electric machine is spaced radially inward relative to said inner wall of said rotating detonation combustor.

6. The rotating detonation combustor system of claim 5, wherein said electric machine is disposed between said turbine wheel and said compressor wheel.

7. The rotating detonation combustor system of claim 1, wherein said electric machine is disposed between said turbine wheel and said compressor wheel.

8. The rotating detonation combustor system of claim 1, wherein said compressor wheel is disposed between said electric machine and said turbine wheel.

9. The rotating detonation combustor system of claim 1, wherein said turbine wheel is disposed between said electric machine and said compressor wheel.

10. The rotating detonation combustor system of claim 1, wherein said electric machine is further defined as an electric generator configured to only convert rotational motion of said shaft to electrical energy.

11. The rotating detonation combustor system of claim 1, wherein said electric machine is further defined as an electric motor configured to only convert electrical energy to rotational motion of said shaft.

12. The rotating detonation combustor system of claim 1, wherein said electric machine is configured to both convert rotational motion of said shaft to electrical energy, and convert electrical energy to rotational motion of said shaft.

13. The rotating detonation combustor system of claim 1, wherein the fuel that said rotating detonation combustor is configured to receive includes at least one chosen from hydrogen gas, hydrocarbon-based fuels, gasoline, kerosene, natural gas, and jet fuel.

14. The rotating detonation combustor system of claim 1 further comprising a turbine volute housing defining a turbine volute interior and a compressor volute housing defining a compressor volute interior, with said turbine wheel disposed in said turbine volute interior and with said compressor wheel disposed in said compressor volute interior.

15. A method of operating a rotating detonation combustor system, with the rotating detonation combustor system including a rotating detonation combustor extending along an axis, having an outer all extending along and circumferentially about the axis, and having an inner wall extending along and circumferentially about the axis, with the inner wall spaced radially inward relative to the outer wall such that a combustion chamber is defined between the outer wall and the inner wall, and with the electrical generator system including a turbine wheel in fluid communication with the combustion chamber, a shaft rotatable with the turbine wheel, a compressor wheel rotatable with the shaft and in fluid communication with the combustion chamber, and an electric machine rotatable with the shaft, said method comprising the steps of:
rotating the shaft and the compressor wheel with the electric machine; and
delivering compressed oxidizing agent to the combustion chamber.

16. The method of claim 15, wherein the step of delivering compressed oxidizing agent to the combustion chamber comprises flushing the combustion chamber of fuel.

17. The method of claim 15 further comprising the steps of:
delivering a fuel to the combustion chamber;
combusting the fuel and the compressed oxidizing agent in the combustion chamber;
expelling exhaust gas from the combustion chamber; and
rotating the turbine wheel and the shaft with the expelled exhaust gas from the combustion chamber.

18. The method of claim 17, wherein the step of combusting the fuel and the compressed oxidizing agent in the combustion chamber is accomplished with a lean mixture of the fuel and the compressed oxidizing agent.

19. The method of claim 17 further comprising the step of converting rotational motion of the shaft to electrical energy with the electric machine, and wherein the step of rotating the shaft with the electric machine precedes the step of converting rotational motion of the shaft to electrical energy with the electric machine.

20. A method of operating a rotating detonation combustor system, with the rotating detonation combustor system including a rotating detonation combustor extending along an axis, having an outer all extending along and circumferentially about the axis, and having an inner wall extending along and circumferentially about the axis, with the inner wall spaced radially inward relative to the outer wall such that a combustion chamber is defined between the outer wall and the inner wall, and with the electrical generator system including a turbine wheel in fluid communication with the combustion chamber, a shaft rotatable with the turbine wheel, a compressor wheel rotatable with the shaft and in fluid communication with the combustion chamber, and an electric machine rotatable with the shaft, said method comprising the steps of:
delivering compressed oxidizing agent to the combustion chamber;
delivering a fuel to the combustion chamber;
combusting the fuel and the compressed oxidizing agent in the combustion chamber;
expelling exhaust gas from the combustion chamber;
rotating the turbine wheel and the shaft with the exhaust gas from the combustion chamber; and
converting rotational motion of the shaft to electrical energy with the electric machine.
